(19) United States
(12) Patent Application Publication
(10) Pub. No.: US 2025/0043085 A1
(43) Pub. Date: Feb. 6, 2025

(54) STABILISATION OF POLYISOBUTENE

(71) Applicant: BASF SE, Ludwigshafen Am Rhein (DE)

(72) Inventors: Tom Markelj, Ludwigshafen (DE); Peter Schreyer, Weinheim (DE); Tero Mustonen, Ludwigshafen (DE); Paul Lederhose, Ludwigshafen (DE); Doris Schmidt, Herxheim am Berg (DE)

(73) Assignee: BASF SE, Ludwigshafen Am Rhein (DE)

(21) Appl. No.: 18/718,611

(22) PCT Filed: Dec. 7, 2022
(86) PCT No.: PCT/EP2022/084734

§ 371 Date: Jun. 11, 2024

(30) Foreign Application Priority Data
Dec. 14, 2021 (EP) 21214413.3

(51) Int. Cl. C08J 3/20; A23G 4/06; C08K 5/1545

(52) U.S. Cl. CPC C08J 3/203; A23G 4/06; C08K 5/1545; C08J 2323/22

(57) ABSTRACT

A process stabilizes polyisobutenes by processing the polyisobutenes in at least one kneader or extruder. The polyisobutene contains at least one chromanol as a stabilizer, or the chromanol is incorporated into the polyisobutene. The polyisobutene is added to or forms sealants, adhesives, coatings, roofings, white and black filled sheeting, and chewing gum.

The present invention concerns a new process for stabilising polyisobutene, the use of stabilisers therefore, and the thus stabilised polyisobutene.

Polyisobutene is a polymer comprising isobutene in polymerised form and is used e.g. in plasters, adhesives, chewing gum, and sealants. Processing, e.g. blending with other polymers or other components for the desired use, of such polyisobutene usually takes place in extruders under application of heat and shear energy. On exposure to such processing conditions or atmospheric conditions such polyisobutene undergoes degradation, especially to oxidation and light-induced depolymerisation and degradation. Depolymerisation of polyisobutene leads to a content of free isobutene in the respective polyisobutene which is prohibitive for the use of such polyisobutene in chewing gum: At present the threshold for isobutene monomer in polyisobutene suitable for chewing gums is 30 ppm.

So far often butylated hydroxytoluene (2,6-di-tert-butyl-4-methylphenol, BHT) has often been used as stabiliser, however, BHT tends to discolour the polyisobutene. BHT may also be used as ingredient in chewing gum compositions, see e.g. U.S. Pat. No. 5,800,847 A.

Therefore, polyisobutene requires a stabiliser against such degradation and a need for stabilisers with a better solubility in polyisobutene, better incorporation into polyisobutene and/or a better efficacy exists.

EP 35677 A1 discloses a process for a deliberate depletion of polyisobutene with an average Mv of more than 2,000,000 to lower molecular polyisobutene with an average Mv of less than 200,000 in extruders at 150 to 400° C. The use of tocopherols in amounts of up to 100 wt.ppm yields the lower molecular polyisobutenes with less formation of carbon black compared with the same amounts of 2,6-di tert, butyl-4-methyl phenol.

The problem underlying the present invention differs from that of EP 35677 A1 insofar polyisobutene employed in extruders shall maintain its molecular weight as far as possible, the depletion according to the process of EP 35677 A1 be prevented.

Other sterically hindered phenols are disclosed as stabilisers for polyisobutenes, see e.g. WO 2015/095960 A1.

Those sterically hindered phenolic antioxidants such as BHT or those used in the examples of WO 2015/095960 A1 may generate various thermal reaction or degradation products during extrusion and processing of polymers at high temperatures and radiolytic degradation products during sterilization with gamma-rays or electron beam irradiation.

Such organic degradation products from phenolic antioxidants migrating from polyethylene pipes into drinking water were identified by Arvin et al. (Brocca, D., Arvin, E, Mosbaek: Water Res., 36, 3675-3680, 2002) and are generally known as “Arvin substances” (see FIG. 2 in Arvin et al.).

Therefore, a need exists for stabilisers of polyisobutene which do not form such Arvin substances

For the sake of the present invention sterically hindered phenols are referred to as compounds with a phenolic moiety and at least one, preferably two sterically demanding groups in at least one ortho-position to the phenolic hydroxy group. Such sterically demanding groups are preferably radicals comprising at least one tertiary or quaternary carbon atom and/or radicals comprising at least 6 carbon atoms, more preferably selected from the group consisting of iso-propyl, tert-butyl, tert-amyl, cyclopentyl, and cyclohexyl.

Since polyisobutene inter alia may be used in plasters or chewing gum the improved stabilisers must not be skin irritant, harmful or even toxic.

Multi component stabiliser compositions comprising inter alia phenols or chromanols are well known for stabilisation of polymers in general, see e.g. WO 2013/188490 A1, WO 2014/140383 A1 or WO 2016/81823 A1, however, no specific use in polyisobutene is disclosed in these documents.

This problem is solved by the use of at least one chromanols described in detail below in medium or high molecular polyisobutene for protection against degradation.

This problem is solved by a process for processing polyisobutenes in at least one kneader or extruder at a temperature of at least 80 to 160° C. for not more than 2 hours and/or a specific shear energy of at least 0.08 kWh/kg, preferably at least 0.10, more preferably at least 0.15, even more preferably at least 0.15, and especially at least 0.20 kWh/kg polyisobutene, wherein the polyisobutene contains more than 100 to 5000 ppm of at least one chromanol or the at least one chromanol is incorporated into the polyisobutene during the process, and wherein the average molecular weight (measured in the form of the Staudinger Index J₀) decreases not more than 5%.

The certain chromanols according to the present invention are of formula

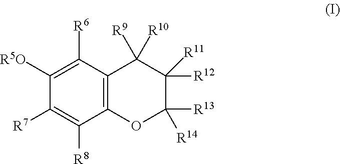

wherein
R⁵, R⁶, R⁷, R⁸, R⁹, R¹⁰, R¹¹, R¹², R¹³ and R¹⁴ are each independently hydrogen, C₁-C₄-alkyl, C₁-C₄-alkyloxy or C₆-C₁₂-aryl,
R⁵ is additionally C₁-C₄-alkylcarbonyl, C₁-C₄-alkyloxycarbonyl, C₆-C₁₂-arylcarbonyl or C₆-C₁₂-aryloxycarbonyl,
R¹³ and R¹⁴ additionally may be C₅-C₃₀-alkyl, C₅-C₃₀-alkenyl, C₅-C₃₀-alkadienyl or C₅-C₃₀-alkatrienyl, preferably C₆-C₂₀-alkyl or -alkatrienyl, more preferably C₁₁-C₁₆-alkyl or -alkatrienyl,
especially C₁₆-alkyl or or C₁₆-alkatrienyl and the radicals mentioned may each optionally be interrupted by one or more oxygen atoms and/or sulfur atoms and/or one or more substituted or unsubstituted imino groups, or be substituted by functional groups, aryl, alkyl, aryloxy, alkyloxy, halogen, heteroatoms and/or heterocycles,
and R¹³ is additionally chlorine.

It is one advantage of antioxidants based on chromanol structures and their derivatives according to the invention, such as Vitamin E, do not degrade into Arvin substances.

For the sake of simplicity these chromanols are referred to as stabilisers within this document.

In this Formula

C₁-C₄-alkyl optionally interrupted by one or more oxygen atoms and/or sulfur atoms and/or one or more substituted or unsubstituted imino groups, or substituted by functional groups, aryl, alkyl, aryloxy, alkyloxy, halogen, heteroatoms and/or heterocycles is, for example, methyl, ethyl, propyl, isopropyl, n-butyl, sec-butyl, tert-butyl, benzyl, 1-phenylethyl, 2-phenylethyl, a, adimethylbenzyl, benzhydryl, p-tolylmethyl, 1-(p-butylphenyl)ethyl, p-chlorobenzyl, 2,4-dichlorobenzyl, p-methoxybenzyl, m-ethoxybenzyl, 2-cyanoethyl, 2-cyanopropyl, 2-methoxycarbonethyl, 2-ethoxycarbonylethyl, 2-butoxycarbonylpropyl, 1,2-di(methoxycarbonyl)ethyl, 2-methoxyethyl, 2-ethoxyethyl, 2-butoxyethyl, diethoxymethyl, diethoxyethyl, 1,3-dioxolan-2-yl, 1,3-dioxan-2-yl, 2-methyl-1,3-dioxolan-2-yl, 4-methyl-1,3-dioxolan-2-yl, 2-isopropoxyethyl, 2-butoxypropyl, 2-octyloxyethyl, chloromethyl, 2-chloroethyl, trichloromethyl, trifluoromethyl, 1,1-dimethyl-2-chloroethyl, 2-methoxyisopropyl, 2-ethoxyethyl, butylthiomethyl, 2-dodecylthioethyl, 2-phenylthioethyl, 2,2,2-trifluoroethyl, 2-hydroxyethyl, 2-hydroxypropyl, 3-hydroxypropyl, 4-hydroxybutyl, 2-aminoethyl, 2-aminopropyl, 3-aminopropyl, 4-aminobutyl, 2-methylaminoethyl, 2-methylaminopropyl, 3-methylaminopropyl, 4-methylaminobutyl, 2-dimethylaminoethyl, 2-dimethylaminopropyl, 3-dimethylaminopropyl, 4-dimethylaminobutyl, 2-hydroxy-2,2-dimethylethyl, 2-phenoxyethyl, 2-phenoxypropyl, 3-phenoxypropyl, 4-phenoxybutyl, 2-methoxyethyl, 2-methoxypropyl, 3-methoxypropyl, 4-methoxybutyl, 2-ethoxyethyl, 2-ethoxypropyl, 3-ethoxypropyl or 4-ethoxybutyl and

C₁-C₂₀-alkyl is methyl, ethyl, iso-propyl, n-propyl, n-butyl, iso-butyl, sek-butyl, tert-butyl, n-hexyl, n-heptyl, n-octyl, 2-ethylhexyl, n-decyl, 2-propylheptyl, n-dodecyl, n-tetradecyl, n-hexadecyl, noctadecyl or n-eicosyl

C₆-C₁₂-aryl optionally interrupted by one or more oxygen atoms and/or sulfur atoms and/or one or more substituted or unsubstituted imino groups, or substituted by functional groups, aryl, alkyl, aryloxy, alkyloxy, halogen, heteroatoms and/or heterocycles, is, for example, phenyl, tolyl, xylyl, α-naphthyl, β-naphthyl, 4-diphenylyl, chlorophenyl, dichlorophenyl, trichlorophenyl, difluorophenyl, methylphenyl, dimethylphenyl, trimethylphenyl, ethylphenyl, diethylphenyl, isopropylphenyl, tert-butylphenyl, dodecylphenyl, methoxyphenyl, dimethoxyphenyl, ethoxyphenyl, hexyloxyphenyl, methylnaphthyl, isopropylnaphthyl, chloronaphthyl, ethoxynaphthyl, 2,6-dimethylphenyl, 2,4,6-trimethylphenyl, 2,6-dimethoxyphenyl, 2,6-dichlorophenyl, 4-bromophenyl, 2- or 4-nitrophenyl, 2,4- or 2,6-dinitrophenyl, 4-dimethylaminophenyl, 4-acetylphenyl, methoxyethylphenyl or ethoxymethylphenyl.

R⁵, R⁶, R⁷, R⁸, R⁹, R¹⁰, R¹¹, R¹², R¹³ and R¹⁴ are preferably each independently hydrogen or C₁-C₄-alkyl and more preferably hydrogen or methyl.

R⁵ is preferably hydrogen, C₁-C₄-alkyl or C₁-C₄-alkylcarbonyl, more preferably hydrogen or C₁-C₄-alkyl, and most preferably hydrogen, methyl or acetyl, especially hydrogen.

In particular, R⁵ and R¹⁰ to R¹² are each hydrogen, R⁶, R⁷ and R⁸ are each independently hydrogen or methyl, and R¹³ and R¹⁴ are each methyl.

R⁵ and R⁹ to R¹² are especially each hydrogen, R⁶, R⁷ and R⁸ especially each methyl, and R¹³ and R¹⁴ especially each methyl.

Preferred 6-chromanol derivatives of formula (I) are 2,2,5,7,8-pentamethyl-6-chromanol, 2,2,5,7-tetramethyl-6-chromanol, 2,2,5,8-tetramethyl-6-chromanol, 2,2,7,8-tetramethyl-6-chromanol, 2,2,5-trimethyl-6-chromanol, 2,2,7-trimethyl-6-chromanol and 2,2,8-trimethyl-6-chromanol, particularly preferred are 2,2,5,7,8-pentamethyl-6-chromanol, 2,2,5,7-tetramethyl-6-chromanol, 2,2,5,8-tetramethyl-6-chromanol and 2,2,7,8-tetramethyl-6-chromanol and very particularly preferred is 2,2,5,7,8-pentamethyl-6-chromanol.

In one embodiment as chromanols tocopherols are preferred according to the present invention, more preferably α-, β-, γ- or δ-tocopherol, even more preferably α-, γ- or δ-tocopherol, and especially α- or γ-tocopherol.

These tocopherols are also referred to as E306, E307, E308, and E309 according to the European food additive numbering system. Furthermore, α-tocopherol is also referred to as vitamin E which can be of natural or synthetic origin.

In one embodiment of the present invention the stabiliser comprises, preferably consists of α-tocopherol.

In another embodiment of the present invention the stabiliser comprises, preferably consists of γ-tocopherol.

In another embodiment of the present invention the stabiliser comprises, preferably consists of synthetic or preferably natural vitamin E. Further to one or more of the above-mentioned α-, β-, γ- or δ-tocopherols such vitamin E may comprise one or more of α-, β-, γ- or δ-tocotrienol.

The tocopherols may be used singly or in mixtures and in enantiomerically pure or enriched form or as racemic mixture of the enantiomers.

For the sake of clarity the tocopherols and tocotrienols are the following compounds of formula (I):

α-tocopherol: R⁵=H, R⁶=methyl, R⁷=methyl, R⁸=methyl, R⁹ to R¹²=H, R¹³=methyl, R¹⁴=(4R,8R)-4,8,12-trimethyltridecyl with (R)-configuration at C₂.

β-tocopherol: R⁵=H, R⁶=methyl, R⁷=H, R⁸=methyl, R⁹ to R¹²=H, R¹³=methyl, R¹⁴=(4R,8R)-4,8,12-trimethyltridecyl with (R)-configuration at C₂.

γ-tocopherol: R⁵=H, R⁶=H, R⁷=methyl, R⁸=methyl, R⁹ to R¹²=H, R¹³=methyl, R¹⁴=(4R,8R)-4,8,12-trimethyltridecyl with (R)-configuration at C₂.

δ-tocopherol: R⁵=H, R⁶=H, R⁷=H, R⁸=methyl, R⁹ to R¹²=H, R¹³=methyl, R¹⁴=(4R,8R)-4,8,12-trimethyltridecyl with (R)-configuration at C₂.

α-tocotrienol: R⁵=H, R⁶=methyl, R⁷=methyl, R⁸=methyl, R⁹ to R¹²=H, R¹³=methyl, R^{14=4,8,12}-trimethyltridecetri (3,7,11) enyl with (R)-configuration at C₂.

β-tocotrienol: R⁵=H, R⁶=methyl, R⁷=H, R⁸=methyl, R⁹ to R¹²=H, R¹³=methyl, R^{14=4,8,12}-trimethyltridecetri (3,7,11) enyl with (R)-configuration at C₂.

γ-tocotrienol: R⁵=H, R⁶=H, R⁷=methyl, R⁸=methyl, R⁹ to R¹²=H, R¹³=methyl, R^{14=4,8,12}-trimethyltridecetri (3,7,11) enyl with (R)-configuration at C₂.

δ-tocotrienol: R⁵=H, R⁶=H, R⁷=H, R⁸=methyl, R⁹ to R¹²=H, R¹³=methyl, R^{14=4,8,12}-trimethyltridecetri (3,7,11) enyl with (R)-configuration at C₂.

The structures are well known in chemical literature.

Another object of the present invention is polyisobutene in general, preferably high molecular polyisobutene comprising at least one stabiliser according to the present invention.

### Polyisobutene

The present invention relates to the stabilisation of high molecular weight polyisobutenes which in the context of the present text means having a viscosity-average molecular weight Mv of 20 000 to 10 000 000 obtainable by polymerizing isobutene or an isobutene-containing monomer mixture.

The viscosity-average molecular weight Mv is calculated from the Staudinger Index J₀ as follows:

$$Mv = {( {J}_{0} \times 100 / 3.06 )}^{1 / 0.65}$$

respectively the number-average molecular weight Mn:

$$Mn = {( {J}_{0} \times 1000 / 2.27 )}^{1 / 0.94}$$

The Staudinger index J₀[cm³/g] is calculated from the flow time at 20° C. through capillary I of an Ubbelohde viscometer via the Schulz-Blaschke equation:

$${J}_{0} = {η}_{sp} / ( c \times ( 1 + 0.31 {η}_{s p} ) ) [ {cm}^{3} / g ]$$

with the specific viscosity nₛₚ being

$${η}_{sp} = ( t / {t}_{0} ) - 1$$

where
t=flow time of the solution, with Hagenbach-Couette correction
t₀=flow time of the solvent, with Hagenbach-Couette correction
c=concentration of the solution in g/cm³.

In the context of the present invention high molecular weight polyisobutenes of this molecular weight is for the reason of simplicity referred to as polyisobutene.

For the preparation of the polymer isobutene or an isobutene-containing monomer mixture is polymerized, suitable isobutene sources are C₄ cuts, more particularly, pure isobutene which generally comprises at most 0.5% by volume of residual impurities such as 1-butene, 2-butenes, butane, water and/or C₁- to C₄-alkanols.

The raw material of C₄ compounds is usually selected from the group consisting of
(a) a C₄ compound material in which an isobutene amount is adjusted to 50 to 75% by weight, obtained by adding high purity isobutene having the isobutene amount of 90 to 100% by weight to C₄ raffinate-1 which is a remainder after extracting 1,3-butadiene from a C₄ compound derived during a naphtha degrading process;
(b) a C₄ compound material in which an isobutene amount is adjusted to 50 to 75% by weight, obtained by adding high amount isobutene mixture having isobutene amount of 80 to 97% by weight, which is generated in an olefin conversion unit (OCU) process that produces propylene by the metathesis of ethylene and 2-butene, to C₄ raffinate-1 which is a remainder after extracting 1,3-butadiene from a C₄ compound derived during a naphtha degrading process;
(c) a C₄ compound material in which an isobutene amount is adjusted to 50 to 75% by weight, obtained by adding high purity isobutene having the isobutene amount of 90 to 100% by weight to butane-butene oil (B-B oil) derived from crude oil refining process;
(d) a C₄ compound material in which an isobutene amount is adjusted to 50 to 75% by weight, obtained by adding high amount isobutene mixture having the isobutene amount of 80 to 97% by weight, which is generated in an olefin conversion unit (OCU) process that produces propylene by the metathesis of ethylene and 2-butene, to butane-butene oil (B-B oil) derived from crude oil refining process;
(e) a C₄ compound material in which an isobutene amount is adjusted to 50 to 75% by weight, obtained by adding a dilute solvent to high purity isobutene having an isobutene amount of 90 to 100% by weight;
(f) a C₄ compound material in which an isobutene amount is adjusted to 50 to 75% by weight, obtained by adding a dilute solvent to high amount isobutene mixture having the isobutene amount of 80 to 97% by weight, which is generated in an olefin conversion unit (OCU) process that produces propylene by the metathesis of ethylene and 2-butene;
(g) a C₄ compound material in which an isobutene amount is adjusted to 50 to 75% by weight, obtained by adding high purity isobutene having the isobutene amount of 90 to 100% by weight to a mixture generated in dehydrogenation reaction that converts isobutane to isobutene; and
(h) a C₄ compound material in which an isobutene amount is adjusted to 50 to 75% by weight, obtained by adding high amount isobutene mixture having the isobutene amount of 80 to 97% by weight, which is generated in an olefin conversion unit (OCU) process that produces propylene by the metathesis of ethylene and 2-butene to a mixture generated in dehydrogenation reaction that converts isobutane to isobutene.

It is preferred to use isobutene-containing technical C₄ hydrocarbon streams, for example, C₄ raffinates, C₄ cuts from isobutane dehydrogenation, C₄ cuts from steamcrackers and from FCC crackers (fluid catalyzed cracking), provided that they have been substantially freed of 1,3-butadiene present therein. Suitable technical C₄ hydrocarbon streams comprise generally less than 500 ppm, preferably less than 200 ppm, of butadiene.

The isobutene from such technical C₄ hydrocarbon streams is polymerized here substantially selectively to the desired isobutene homopolymer without incorporation of significant amounts of other C₄ monomers into the polymer chain. Typically, the isobutene concentration in the technical C₄ hydrocarbon streams mentioned is in the range from 40 to 60% by weight. However, the polyisobutene according to the invention can in principle also be obtained from isobutene-containing C₄ hydrocarbon streams which comprise less isobutene, for example, only 10 to 20% by weight. The isobutene-containing monomer mixture may comprise small amounts of contaminants such as water, carboxylic acids or mineral acids without any critical yield or selectivity losses. It is appropriate to the purpose to avoid accumulation of these impurities by removing such harmful substances from the isobutene-containing monomer mixture, for example, by adsorption on solid adsorbents such as activated carbon, molecular sieves or ion exchangers.

Efficient preparation processes which satisfy the specification for relatively high molecular weight isobutene homopolymers generally entail very low polymerization temperatures. A typical process for preparing such isobutene homopolymers is called the “BASF belt process”, in which liquid isobutene together with boron trifluoride as a polymerization catalyst and a high excess of liquid ethene are passed onto a continuous steel belt of width from 50 to 60 cm, which is configured in a trough shape by suitable guiding and is present in a gas-tight cylindrical casing. By constant evaporation of the ethene at standard pressure, a temperature of −104° C. is set. The heat of polymerization is fully removed as a result. The evaporated ethene is collected, purified and recycled. The resulting polyisobutenes are freed of ethene which still adheres and residual monomers by degassing. The polymerization of this type leads to virtually full isobutene conversion.

In the BASF belt process, the polymerization temperature can be controlled easily and reliably owing to evaporative cooling, i.e. as a result of formation of large vapor passages. However, a disadvantage of the BASF belt process is that, because of lack of movement of the reactants on the belt, sufficient mixing of the reactants and hence product surface renewal does not take place, which can have an adverse effect on the product properties. This leads, for example, to inhomogeneous distribution of the ethene used for evaporative cooling and associated local overheating of the reaction mixture as soon as the ethene has evaporated. Moreover, there can be explosive boiling of the reaction mixture when overheated regions and ethene-rich cold regions come into contact with one another, which then leads to soiling of the reactor wall as a result of entrainment of polymerizing reaction mixture. Another disadvantage is that the inhomogeneous thermal distribution causes unwanted broadening of the molecular weight distribution of the polymer, which is associated with unfavorable product properties. A further disadvantage of the BASF belt process is that the steel belt is subject to wear and hence causes high maintenance costs. A further disadvantage of the BASF belt process is that the reactor walls and the product intake in the downstream workup section (usually an extruder) are not cooled; since polyisobutene is highly tacky above its glass transition temperature, this leads to distinct tackifying of the reactor walls with polymers, which necessitates increased cleaning intensity. A further disadvantage of the BASF belt process is that boron trifluoride present in the recycled ethene stream is highly corrosive at relatively high temperatures, which causes a high level of maintenance for the ethene workup circuit.

A further customary process for preparing relatively high molecular weight isobutene homopolymers is the “Exxon slurry process”, in which the polymerization is performed at −80 to −85° C. in a stirred tank equipped with a cooling jacket charged with liquid ethene. The catalyst system used is anhydrous aluminum chloride in methyl chloride. Owing to the very vigorous stirring, the polymer is obtained as a slurry consisting of small droplets which flows via an intermediate vessel into a degassing vessel. Here, the slurry is treated with steam and hot water, such that the volatile constituents (essentially unconverted isobutene and methyl chloride) can be removed and sent to reprocessing. The remaining liquid slurry of the polymer particles is worked up by removing catalyst residues, solvent residues and isobutene residues.

In the Exxon slurry process, although intensive mixing and product surface renewal takes place, the polymerization temperature is difficult to control solely by the jacket cooling. Since the polymer cannot completely be prevented from adhering to the reactor and apparatus walls, reactor and apparatus have to be cleaned from time to time.

The BASF belt process and the Exxon slurry process are described in detail in Ullmann's Encyclopedia of Industrial Chemistry, 5th edition, Vol. A21, pp. 555-561, under “Polyisobutylenes”.

Further polymerisation processes are disclosed in WO 15/095960 and WO 16/000074 where polymerisation takes place in an organic solvent and the polyisobutene particles are obtained as aqueous slurries.

Furthermore, a preferred process for the polymerisation of polyisobutene is described in WO 2017/216022 A1, preferably from page 2, line 22 to page 5, line 42.

The stabiliser usually is effective in the process according to the invention while essentially maintaining the molecular weight in weight amounts of more than 100 to 5000 ppm referring to the weight of the polyisobutene, preferably from 110 to 3000 ppm, more preferably 125 to 2000, even more preferably 150 to 1000 ppm, and especially 200 to 500 ppm by weight.

The stabiliser may be added to the polyisobutene in solid or molten form or as solution in at least one solvent. Such solvent is preferably removed while incorporation into the polyisobutene. Preferably the stabiliser is added as solid or melt, more preferably in liquid or molten form.

The stabiliser is preferably incorporated into the polyisobutene with the help of at least one kneader or extruder, more preferably at least one extruder using shearing forces.

The one or more extruders are preferably heated to temperatures of more than 80° C., especially more than 100° C. The temperature should not exceed a temperature of 160° C., preferably less than 150° C.

It is possible in principle to use all customary single-shaft and twin-shaft and multishaft extruders for the incorporation of the stabiliser into the polyisobutene. In the case of twin-shaft and multishaft extruders, the shafts may work in a corotatory or contrarotatory manner. The shafts in single-shaft and multishaft extruders are normally equipped with kneading and/or conveying elements. These apparatuses are generally self-cleaning. The shaft speeds are generally in the range from 10 to 500, and especially from 15 to 350 revolutions per minute.

The incorporation of the stabiliser into the polyisobutene may be combined with the working step of degassing of the volatile constituents in the product, such as residual monomers and solvents. The degassing and the purification of the product can be facilitated by applying a vacuum; more particularly, a pressure of less than 700 mbar is employed for this purpose, especially of less than 200 mbar and in particular of less than 100 mbar.

In a specific design, the shafts may be configured as screw shafts whose channels intermesh and whose internal shaft diameter is preferably constant over the entire length. Preferred construction materials for the extruders described are steels or stainless steels. It is also advantageous to introduce an inert gas, for example nitrogen, into one or more segments of the extruder in order to promote the degassing operation.

Extruders are usually used to incorporate other ingredients necessary for the desired application into the polyisobutene or to mix the polyisobutene with other polymers or constituents. It is a disadvantage that this process may lead to degradation of the polyisobutene due to shear stress and/or thermal strain. As a consequence the product exhibits a lower average molecular weight or light weight volatile by-products due to polymer chain degradation or colouration.

It is an advantage of the present invention that the stabilisers mentioned above are also effective to reduce or even prevent such degradation during the kneading or extrusion process.

Therefore, another object of the present invention is a process for processing polyisobutenes in at least one kneader or extruder at a temperature of at least 80, preferably at least 100, more preferably at least 120° C. and/or a specific shear energy of at least 0.08 kWh/kg, preferably at least 0.10, more preferably at least 0.15, even more preferably at least 0.15, and especially at least 0.20 kWh/kg polyisobutene, wherein the polyisobutene contains more than 100 to 5000 ppm of at least one stabiliser according to the invention or the at least one stabiliser is incorporated into the polyisobutene during the process. Preferred amounts of stabiliser are from 110 to 3000 ppm, more preferably 125 to 2000, even more preferably 150 to 1000 ppm, and especially 200 to 500 ppm by weight.

The upper limit of the temperature of the at least one kneader or extruder is 160° C., preferably less than 150° C., more preferably not more than 140° C.

The residence time in the at least one kneader or extruder at the temperature given is not more than 2 hours, preferably not more than 1.5 hours, more preferably not more than 1.25 hours, and especially not more than 1 hour.

The at least one stabiliser can be introduced into the polyisobutene in one or more doses, preferably in one portion.

The at least one stabiliser can be introduced into the polyisobutene prior to adding other ingredients necessary for the application or together with such ingredients.

Under these conditions the average molecular weight (measured in the form of the Staudinger Index J₀) decreases not more than 5%, preferably not more than 4%, more preferably not more than 3%, even more preferably not more than 2.5%, and especially not more than 2%.

It was found that the stabilised polyisobutene products according to the present invention are particularly useful for the preparation of compounds for specific applications.

Such applications include sealants, adhesives, coatings and roofings as well as white and black filled sheeting.

Therefore, the invention also encompasses the use of the polyisobutylenes according to the invention in or as sealants, adhesives, coatings and roofings as well as white and black filled sheeting.

The polymer products are also useful in tire sidewalls and tread compounds. In sidewalls, the polyisobutylenes characteristics impart good ozone resistance, crack cut growth, and appearance.

With special preference the stabilised polyisobutene according to the present invention is used as or as an ingredient in chewing gums, since the stabilisers are non-toxic and have approval as a food ingredient. In a preferred embodiment the chromanols of formula (I) are used as an ingredient in chewing gums, more preferably the stabiliser comprises, preferably consists of one or more of the above-mentioned α-, β-, γ- or δ-tocopherols and/or one or more of α-, β-, γ- or δ-tocotrienol. Among those compounds α- and γ-tocopherol are preferred.

In an especially preferred embodiment the stabiliser comprises, preferably consists of synthetic or preferably natural vitamin E.

Another object of the present invention is a chewing gum, comprising polyisobutene comprising at least one stabiliser comprising, preferably consisting of one or more of α-, β-, γ- or δ-tocopherols and/or one or more of α-, β-, γ- or δ-tocotrienol, preferably one or more of α- and γ-tocopherol, and especially synthetic or preferably natural vitamin E.

In a preferred embodiment the polyisobutene for use in chewing gum has a content of free, monomeric isobutene of less than 30 ppm, preferably less than 25, more preferably less than 20, even more preferably less than 15, and especially less than 10 ppm by weight.

In another preferred embodiment the stabilised polyisobutene according to the present invention is used as or as an ingredient in sealants for construction, piping and/or roofing, since the stabilisers are non-toxic, have approval as a food ingredient and do not form so called Arvin substances in drinking or rain- or waste-water streams, originating from reactions and degradation of phenolic antioxidants during polymer processing. In a preferred embodiment the chromanols of formula (I) are used as an ingredient in sealants for construction, piping and/or roofing, more preferably the stabiliser comprises, preferably consists of one or more of the above-mentioned α-, β-, γ- or δ-tocopherols and/or one or more of α-, β-, γ- or δ-tocotrienol. Among those compounds α- and γ-tocopherol are preferred.

In an especially preferred embodiment the stabiliser comprises, preferably consists of synthetic or preferably natural vitamin E.

Another object of the present invention is a sealant, comprising polyisobutene comprising at least one stabiliser comprising, preferably consisting of one or more of α-, β-, γ- or 0-tocopherols and/or one or more of α-, β-, γ- or δ-tocotrienol, preferably one or more of α- and γ-tocopherol, and especially synthetic or preferably natural vitamin E.

The invention is further illustrated by the following examples without being restricted thereto.

### EXAMPLES

### Analytics

Staudinger Index J₀ was determined of solutions of the polyisobutene sample in 2,2,4-trimethylpentane (concentration 0.002 to 0.01 g/cm³) at 20° C. according to DIN 51562 in an

Ubbelohde capillary microviscometer (AVS PRO III supplied by Schott Geräthe GmbH), Capillary Ic, No. 53713.

### Components

Polyisobutene 1 (PIB1): High-molecular weight polyisobutene with a viscosity average molecular weight (Mv) of 425 000 g/mol and a Staudinger Index J₀=128-150 cm³/g, commercially available as Oppanol N50 from BASF SE, Ludwigshafen.

Polyisobutene 2 (PIB2): Medium-molecular weight polyisobutene with a viscosity average molecular weight (Mv) of 85 000 g/mol and a Staudinger Index J₀=45.9-51.6 cm³/g, commercially available as Oppanol B15 from BASF SE, Ludwigshafen.

Stabiliser 1:2,6-di-tert-butyl-4-methylphenol, BHT (comparative)

Stabiliser 2: α-tocopherol (European food additive E307)

### Example 1—Stability in Extruding Process

Polyisobutene 1 with an initial value J₀ 133.1 cm³/g were placed in a laboratory extruder (ThermoFischer Haake Rheomix OS, twin-screw, 120 cm³ volume) at the temperature, rotational speed, and residence time given in the table.

The Staudinger Index J₀ [cm³/g] was determined of the comparative and stabilised samples after extrudation and listed in the table.

Initial sample had Staudinger Index value J₀ of 133.1 cm³/g and after kneading, lower J₀ value means that the polymer chains were broken in the harsh process conditions.

| | | | Rotational | Residence | |
|---|---|---|---|---|---|
| | | Temperature | Speed | time | J₀ |
| Entry | Additive | [° C.] | [rpm] | [min] | [cm³/g] |
| Reference | — | — | — | — | 133.1 |
| 1 | — | 160 | 20 | 60 | 79.3 |
| 2 | — | 160 | 20 | 120 | 67.2 |
| 3 | 250 ppm | 160 | 50 | 60 | 130.9 |
| | Stabiliser 1 | | | | |
| 4 | 250 ppm | 160 | 50 | 60 | 132.0 |
| | Stabiliser 2 | | | | |
| 5 | 250 ppm | 160 | 50 | 120 | 129.1 |
| | Stabiliser 1 | | | | |
| 6 | 250 ppm | 160 | 50 | 120 | 131.5 |
| | Stabiliser 2 | | | | |
| 7 | 125 ppm | 160 | 50 | 60 | 130.6 |
| | Stabiliser 1 | | | | |
| 8 | 125 ppm | 160 | 50 | 60 | 131.5 |
| | Stabiliser 2 | | | | |
| 9 | 125 ppm | 160 | 50 | 120 | 128.4 |
| | Stabiliser 1 | | | | |
| 10 | 125 ppm | 160 | 50 | 120 | 131.0 |
| | Stabiliser 2 | | | | |

### Example 2—Stability in Extruding Process and Depolymerization to Isobutene in High Molecular Weight Polyisobutenes

Polyisobutene 1 with an initial value J₀ 141.8 cm³/g were placed in a laboratory extruder (ThermoFischer Haake Rheomix OS, twin-screw, 120 cm³ volume) at the temperature, rotational speed, and residence time given in the table.

The Staudinger Index J₀ [cm³/g] was determined of the comparative and stabilised samples after extrudation and listed in the table.

Initial sample had Staudinger Index value J₀ of 141.1 cm³/g and after kneading, lower J₀ value means that the polymer chains were broken in the harsh process conditions.

| | | | Rotational | Residence | | Isobutene |
|---|---|---|---|---|---|---|
| | | Temperature | Speed | time | J₀ | content |
| Entry | Additive | [° C.] | [rpm] | [min] | [cm³/g] | [ppm] |
| Reference | — | — | — | — | 141.1 | <2 |
| 1 | — | 160 | 50 | 60 | 65.1 | 29-34 |
| 2 | 125 ppm | 160 | 50 | 60 | 130.8 | <2 |
| | Stabiliser 1 | | | | | |
| 3 | 125 ppm | 160 | 50 | 60 | 139.5 | <2 |
| | Stabiliser 2 | | | | | |
| 4 | 125 ppm | 160 | 50 | 120 | 93.5 | 4-5 |
| | Stabiliser 1 | | | | | |
| 5 | 125 ppm | 160 | 50 | 120 | 137.4 | <2 |
| | Stabiliser 2 | | | | | |

### Example 3—Stability in Extruding Process and Depolymerization to Isobutene in Medium Molecular Weight Polyisobutenes

Polyisobutene 2 with an initial value J₀ 47.9 cm³/g were placed in a laboratory extruder (ThermoFischer Haake Rheomix OS, twin-screw, 120 cm³ volume) at the temperature, rotational speed, and residence time given in the table.

The Staudinger Index J₀ [cm³/g] was determined of the comparative and stabilised samples after extrudation and listed in the table.

Initial sample had Staudinger Index value J₀ of 47.9 cm³/g and after kneading, lower J₀ value means that the polymer chains were broken in the harsh process conditions.

| | | | | | | Isobutene | Isobutene |
|---|---|---|---|---|---|---|---|
| | | | Rotational | Residence | | content | content |
| | | Temp | Speed | time | J₀ | initial | 24 h, 160° C. |
| Entry | Additive | [° C.] | [rpm] | [min] | [cm³/g] | [ppm] | [ppm] |
| Ref | — | — | — | — | 47.9 | 22 | 167 |
| 1 | — | 120 | 20 | 60 | 47.3 | 14 | 183 |
| 2 | 125 ppm | 120 | 20 | 60 | 48.4 | 12 | 126 |
| | Stabiliser 1 | | | | | | |
| 3 | 125 ppm | 120 | 20 | 60 | 48.2 | 12 | 66 |
| | Stabiliser 2 | | | | | | |
| 4 | 250 ppm | 120 | 20 | 60 | 47.6 | 7 | 37 |
| | Stabiliser 1 | | | | | | |
| 5 | 250 ppm | 120 | 20 | 60 | 47.5 | 10 | 7 |
| | Stabiliser 2 | | | | | | |

### Example 4—Oxidation Induction Time

Oxidation induction time or OIT is a standardized test performed in a differential scanning calorimetry (DSC) which measures the level of thermal stabilization of the material tested. The time between melting and the onset of decomposition in isothermal conditions is measured. The atmosphere is nitrogen up to melting point and then it is changed to oxygen. The lower the value, the earlier the decomposition occurs.

Polyisobutene 1 with an initial value J₀ 133.1 cm³/g were placed in a laboratory extruder (ThermoFischer Haake Rheomix OS, twin-screw, 120 cm³ volume) at the temperature, rotational speed, and residence time given in the table, followed by OIT measurement.

| | | | Rotational | Residence | | Oxidation |
|---|---|---|---|---|---|---|
| | | Temp | Speed | time | J₀ | Induction |
| Entry | Additive | [° C.] | [rpm] | [min] | [cm³/g] | Time [min] |
| Ref | — | — | — | — | 133.1 | — |
| 1 | — | 120 | 20 | 120 | 68.6 | 2.9 |
| 2 | 500 ppm | 120 | 20 | 120 | 131.9 | 42.5 |
| | Stabiliser | | | | | |
| | 1 | | | | | |
| 3 | 500 ppm | 120 | 20 | 120 | 131.9 | 123.3 |
| | Stabiliser | | | | | |
| | 2 | | | | | |

1. A process for stabilising polyisobutenes, comprising:
processing polyisobutenes in at least one kneader or extruder at a temperature of at least 80 to 160° C. for not more than 2 hours and/or a specific shear energy of at least 0.08 kWh/kg,
wherein the polyisobutene contains more than 100 to 5000 ppm of at least one stabiliser comprising at least one chromanol, or the at least one chromanol is incorporated into the polyisobutene during the process, and
wherein an average molecular weight (measured in the form of the Staudinger Index J₀) decreases not more than 5%,
wherein the at least one chromanol is of formula 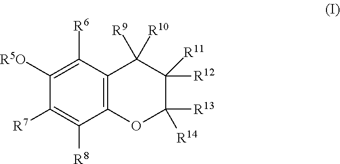
wherein R⁵, R⁶, R⁷, R⁸, R⁹, R¹⁰, R¹¹, R¹², R¹³ and R¹⁴ are each independently hydrogen, C₁-C₄-alkyl, C₁-C₄-alkyloxy or C₆-C₁₂-aryl and
R⁵ is additionally C₁-C₄-alkylcarbonyl, C₁-C₄-alkyloxycarbonyl, C₆-C₁₂-arylcarbonyl or C₆-C₁₂-aryloxycarbonyl,
R¹³ and R¹⁴ additionally may be C₅-C₃₀-alkyl, C₅-C₃₀-alkenyl, C₅-C₃₀-alkadienyl or C₅-C₃₀-alkatrienyl,
and the radicals mentioned may each optionally be interrupted by one or more oxygen atoms and/or sulfur atoms and/or one or more substituted or unsubstituted imino groups, or be substituted by functional groups, aryl, alkyl, aryloxy, alkyloxy, halogen, heteroatoms and/or heterocycles,
and R¹³ is additionally chlorine.

2. The process according to claim 1, wherein the at least one stabiliser is a chromanol of formula (I) selected from the group consisting of 2,2,5,7,8-pentamethyl-6-chromanol, 2,2,5,7-tetramethyl-6-chromanol, 2,2,5,8-tetramethyl-6-chromanol, 2,2,7,8-tetramethyl-6-chromanol, 2,2,5-trimethyl-6-chromanol, 2,2,7-trimethyl-6-chromanol and 2.2,8-trimethyl-6-chromanol.

3. The process according to claim 1, wherein the at least one stabiliser comprises a chromanol of formula (1) selected from the group consisting of α-tocopherol, β-tocopherol, γ-tocopherol and δ-tocopherol and α-tocotrienol, β-tocotrienol, γ-tocotrienol and δ-tocotrienol.

4. The process according to claim 1, wherein the at least one stabiliser comprises a chromanol of formula (1) selected from the group consisting of α-tocopherol and γ-tocopherol.

5. The process according to claim 1, wherein the at least one stabiliser comprises a chromanol of formula (I) comprising vitamin E of natural or synthetic origin.

6. The process according to claim 3, wherein the α-tocopherol, β-tocopherol, γ-tocopherol, or δ-tocopherol may be used singly or in mixtures and in enantiomerically pure or enriched form or as a racemic mixture of enantiomers.

7. A polyisobutene with a viscosity-average molecular weight Mv of 20,000 to 10,000,000 cm³/g and a content of free, monomeric isobutene of less than 30 ppm, comprising more than 100 to 5000 ppm by weight of at least one stabiliser, wherein the at least one stabiliser is at least one chromanol, wherein an average molecular weight (measured in the form of the Staudinger Index J₀) decreases not more than 5%, wherein the at least one chromanol is of formula 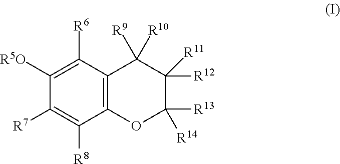
wherein R⁵, R⁶, R⁷, R⁸, R⁹, R¹⁰, R¹¹, R¹², R¹³ and R¹⁴ are each independently hydrogen, C₁-C₄-alkyl, C₁-C₄-alkyloxy or C₆-C₁₂-aryl and
R⁵ is additionally C₁-C₄-alkylcarbonyl, C₁-C₄-alkyloxycarbonyl, C₆-C₁₂-arylcarbonyl or C₆-C₁₂-aryloxycarbonyl,
R¹³ and R¹⁴ additionally may be C₅-C₃₀-alkyl, C₅-C₃₀-alkenyl, C₅-C₃₀-alkadienyl or C₅-C₃₀-alkatrienyl,
and the radicals mentioned may each optionally be interrupted by one or more oxygen atoms and/or sulfur atoms and/or one or more substituted or unsubstituted imino groups, or be substituted by functional groups, aryl, alkyl, aryloxy, alkyloxy, halogen, heteroatoms and/or heterocycles,
and R¹³ is additionally chlorine.

8. The polyisobutene according to claim 7, wherein the polyisobutene is added to or forms sealants, adhesives, coatings, roofings, or white and black filled sheeting.

9. A chewing gum, comprising:
the polyisobutene according to claim 7.

10. The chewing gum according to claim 9, wherein the polyisobutene has a content of free, monomeric isobutene less than 25 ppm by weight.

11. The polyisobutene according to claim 8, wherein the polyisobutene comprises;
at least one stabiliser comprising a chromanol of formula (1) comprising one or more of α-tocopherol, β-tocopherol, γ-tocopherol or δ-tocopherol and/or one or more of α-tocotrienol, β-tocotrienol, γ-tocotrienol or δ-tocotrienol.

12. A chewing gum, comprising:
a polyisobutene with a content of free, monomeric isobutene of less than 30 ppm comprising at least one stabiliser comprising one or more of α-, β-, γ- or δ-tocopherols and/or one or more of α-, β-, γ- or δ-tocotrienol.

13. The process according to claim 1, wherein the specific shear energy is at least 0.20 kWh/kg polyisobutene, and R¹³ and R¹⁴ are C₁₆-alkyl or C₁₆-alkatrienyl.

14. The process according to claim 1, wherein the at least one stabiliser is 2,2,5,7,8-pentamethyl-6-chromanol.

15. The polyisobutene according to claim 9, wherein the polyisobutene has a content of free, monomeric isobutene less than 10 ppm by weight.

16. The polyisobutene according to claim 11, wherein the at least one stabiliser comprises natural vitamin E.

17. The chewing gum according to claim 12, wherein the at least one stabiliser comprises natural vitamin E.
